(19) United States
(12) Patent Application Publication
(10) Pub. No.: US 2026/0201978 A1
(43) Pub. Date: Jul. 16, 2026

(54) VALVE WITH IMPROVED PISTON BALANCING

(71) Applicant: DANFOSS A/S, Nordborg (DK)

(72) Inventors: Bjarke Skovgård Dam, Nordborg (DE); Kristian THERKILDSEN, Nordborg (DE); Klaus HALLDORSSON, Nordborg (DE)

(21) Appl. No.: 19/133,929

(22) PCT Filed: Oct. 25, 2023
(86) PCT No.: PCT/EP2023/079840

§ 371 Date: May 29, 2025

(30) Foreign Application Priority Data
Dec. 23, 2022 (DK) PA202201209

(51) Int. Cl. F16K 39/02; F16K 1/36

(52) U.S. Cl. CPC F16K 39/022; F16K 1/36

(57) ABSTRACT

A valve (10) for regulating a fluid flow between a first and a second port (16, 18) of a valve housing (12) includes a piston (30) movably arranged within a valve cylinder (20). The piston (30) is axially movable within the valve cylinder (20) at least between an opened position in which the fluid can flow between the first and second ports (16, 18) and a closed position in which a front surface (32) of the piston (30) blocks a flow of the fluid. A balance chamber (34) is arranged behind the piston (30), opposite to the front surface (32). The front surface (32) of the piston (30) includes a first opening (36a) with a first channel (38a) connected to the balance chamber (34) and a second opening (36b) with a second channel (38b) connected to the balance chamber (34). Each of the first and second openings (36a, 36b) are arranged at a distance (r1, r2) from a center (c) of the front surface (32) of the piston (30). The first opening (36a) is arranged at a first radial distance (r1) from the center (c) of the front surface (32) of the piston (30), and the second opening (36b) is arranged at a second radial distance (r2) from the center (C) of the front surface (32) of the piston (30). In order to provide improved balancing, the first distance (r1) is greater than the second distance (r1).

### CROSS-REFERENCE TO RELATED APPLICATIONS

This application is a National Stage application of International Patent Application No. PCT/EP2023/079840, filed on Oct. 25, 2023, which claims priority to Danish Patent Application No. PA202201209, filed on Dec. 23, 2022, each of which is hereby incorporated by reference in its entirety.

### TECHNICAL FIELD

The invention relates to a valve for regulating a fluid flow between a first and a second port.

### BACKGROUND

In valves with a movable piston as regulating element, the piston can be balanced by a balance chamber behind the piston (i.e., opposite to the front surface of the piston), connected to an inlet port so that fluid pressure acts on the piston from both sides.

EP-A-3273124 discloses a valve device for controlling media flows of any type by means of a valve control piston longitudinally movable in a valve housing which controls a media connection between an inlet and an outlet. The valve control piston is guided in a valve housing in a pressure-balanced manner with regard to the media pressure present at the pressure supply inlet by means of a compensation device comprising two damping bores connected to a media-carrying compensating chamber of the valve housing.

In particular for valves regulating fluids under very high pressure, such as for example regulating valves in the field of industrial refrigeration for high refrigerant working pressure of up to and above 50 bar, balancing of the piston plays an important role in order to minimize the actuation forces necessary for control of the piston.

It can be considered an object to provide a valve with improved balancing of the piston, thus ensuring control over movement of the piston while minimizing the forces necessary therefor.

### SUMMARY

The invention addresses this object by a valve according to claim 1. Dependent claims refer to preferred embodiments of the invention.

The present inventors have found that while known piston balancing arrangements can achieve suitable balancing in a closed state of the valve, an at least partly opened state of the valve can lead to pressure gradients across a front surface of the piston. The inventors have determined that in this situation the position of openings in the front surface of the piston which are connected to a balance chamber arranged behind the piston may have a significant impact on balancing.

The valve according to the invention is provided for regulating a fluid flow between a first port, e.g. inlet, and a second port, e.g. outlet of a valve housing. The fluid may e.g. be a liquid, gas or mixture thereof.

The valve comprises a piston arranged axially movable within a valve cylinder, at least between an opened and a closed position, as well as preferably partly opened positions in between. In the opened position fluid can flow between the first and second ports, whereas in the closed position a front surface of the piston blocks a flow of the fluid. Preferably, the valve cylinder comprises one or more radial openings, here referred to as window openings, such that an axial positioning of the front surface of the piston relative to the window opening(s) provides a regulating function of the valve including variable degrees of valve opening states to regulate the amount of fluid to pass between the ports, depending on a pressure difference.

The valve further comprises a balance chamber arranged behind the piston, i.e. opposite to the front surface. Within the front surface of the piston are formed at least two openings, including a first opening connected to the balance chamber via a first channel and a second opening connected to the balance chamber via a second channel. Thus, the fluid pressure in front of the front surface of the piston and in the balance chamber can equalize through the connections formed by the at least two openings and connected channels.

The piston and its front and back surfaces can have a variety of different shapes. While the front surface may be concave, so that the piston may be partially or even fully hollow and open towards the front, it is preferred that the front surface is either plane or may be convex, i.e. has one or more raised portions towards the front, in particular a protruding tip. Preferably, the piston may be closed towards the front, and the front surface may be closed and continuous, except for the openings provides at the channels connected to the balance chamber.

A back surface of the piston, bordering the balance chamber, may be flat but preferably comprises one or more steps. In particular, a hollow space may be provided in the piston, e.g. a central bore, which forms part of the balance camber. The channels extending from the openings in the front surface may be connected to the hollow space.

The first and second openings are located within the front surface of the piston such that they are not arranged in the center, but both arranged at a distance from a center of the front surface, preferably at a periphery thereof. The position of the openings may be regarded in a front view of the piston, in which the front surface appears preferably circular. The first opening is arranged at a first radial distance from the center of the front surface of the piston and the second opening is arranged at a second radial distance from the center of the front surface of the piston.

According to the invention, the first distance is greater than the second distance. Thus, the first and second openings are not arranged at an equal distance from the center, but the first opening is arranged farther away from the center than the second opening. In particular in the preferred case of a circular shape of the openings, both distances may be measured between the center of the front surface of the piston and the center of the respective openings.

The inventors have recognized that in particular for a partially opened valve the fluid pressure is not uniform over the front surface of the piston, but that a non-uniform pressure distribution forms. The first and second openings may be considered samples or measurements taken of the fluid pressure at the specified locations. As explained, both the first and second openings are connected to the balance chamber, so that a fluid pressure will be established within the balance chamber corresponding to a combination, such as an average, of the fluid pressure values present in front of both openings.

The inventors have recognized that at least in some embodiments a symmetrical arrangement of the openings, in particular an arrangement under equal radial distances from the center, can lead to incomplete balancing because in some pressure distributions pressure readings taken by symmetrically arranged openings may not accurately reflect the resulting average pressure. However, by arranging the first and openings non-symmetrically within the front surface of the piston, such as under different distances from the center thereof, the resulting pressure in the balance chamber behind the piston more closely corresponds to an overall average of the pressure in front of the piston, so that the respective forces have been found to compensate better than for a symmetrical arrangement.

Thus, the valve with the non-symmetrical placement of openings according to the invention can improve balancing, allowing for reduced force required to control the axial position of the piston with a drive arrangement, such as a spindle drive.

According to a preferred embodiment of the invention, the first distance can be at least 3% greater than the second distance, preferably 5% or more. Further preferred, the first and second distances differ by no more than 50%, preferably by less than 25%, and particularly preferred by 15% or less.

In a preferred embodiment, the piston has a radial extension, i.e. half of a diameter measured at the front surface regarded in front view. Preferably, both the first and the second radial distances of the openings to the center are at least 40% of the radial extension of the piston. Further preferred both openings are positioned more towards the periphery of the front surface than to the center, i.e., both radial distances are greater than 50% of the radial extension, still further preferred more than 60%, and particularly preferred more than 70%.

In a preferred embodiment of the invention, the valve cylinder may comprise one or more window openings, i.e. radial openings. The inside of the valve cylinder may preferably be connected to the first port (preferably inlet) of the valve housing. The windows openings may be arranged to connect the inside of the valve cylinder to the second port, preferably the outlet. As will become apparent in connection with preferred embodiments, different configurations of the valve may have a different number of windows openings, which are preferably distributed around the circumference of the valve cylinder. While theoretically only one window opening may be provided, it is preferred to provide at least two window openings. In an arrangement with two window openings, these are preferably arranged opposite to each other. In further configurations, more window openings, such as 3, 4, 5, 6 or more may be provided.

The inventors have recognized that for a partially opened valve the pressure distribution over the piston front surface depends on the window openings. For a configuration with few window openings, such as e.g. one, two or three, the pressure distribution will generally differ rather strongly in different positions, whereas the pressure distribution will tend to be more uniform for configurations with more window openings such as five, six or more.

In a particularly preferred embodiment, one of the first and second openings, arranged at a first position within the front surface of the piston, may be arranged in front of one of the window openings, whereas the other one of the first and second openings may be arranged at a second position within the front surface of the piston which is not front of one of the window openings. In this way, as a pressure distribution is formed dependent on the position of the windows, the fluid pressure present in front of the openings will likely differ, such that the combined pressure established in the balance chamber may well reflect an average value and thus provide good balancing. In this context, the expression “in front of a window opening” may e.g. be understood as referring to a position within a section of the front surface of the piston, visible in front view, which is bordered by radial lines extending from the center to the edges of the window opening.

While it is possible that the first and second openings may be arranged, in front view, in a straight line with the center of the front surface of the piston, it is particularly preferred to arrange them in positions such that they do not form a straight line with the center. Preferably, the first and second openings may be provided at positions within the front surface of the piston such that the position of the first opening defines a first radius from the center and the second opening defines a second radius from the center. An angle formed between the first and second radius may preferably be greater than 20° and less than 160°, further preferred greater than 60°, particularly preferred greater than 100°.

### BRIEF DESCRIPTION OF THE DRAWINGS

In the following, embodiments of the invention will be described with reference to the drawings, in which

FIG. 1 shows a first embodiment of a valve in a longitudinal sectional view;

FIG. 2 shows a portion the valve of FIG. 1 in a cross-sectional view taken along A . . . A;

FIG. 2a shows an enlarged portion of the cross-sectional view of FIG. 2 including a valve cylinder and a piston front surface;

FIGS. 3, 4 show a valve according to a second embodiment in a longitudinal sectional view and in a cross-sectional view;

FIGS. 5, 6 show a valve according to a third embodiment in a longitudinal sectional view and in a cross-sectional view.

### DETAILED DESCRIPTION

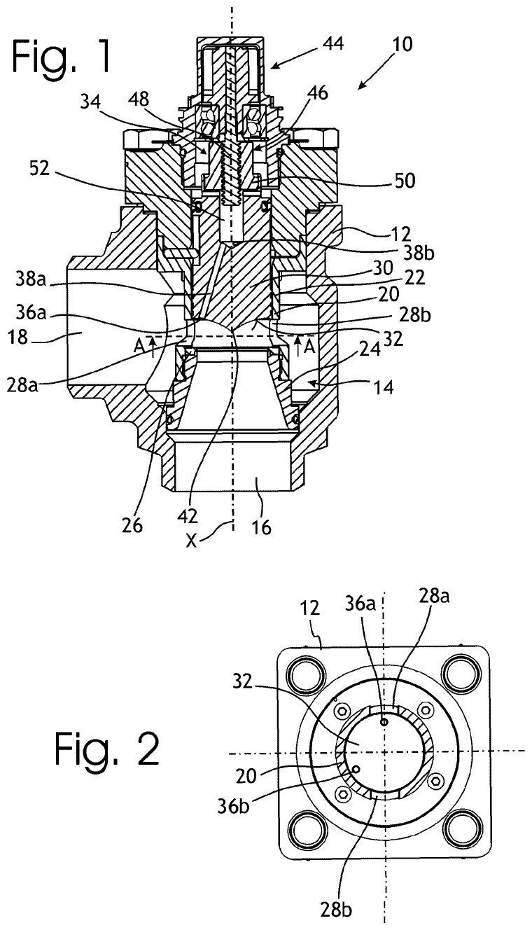

FIG. 1 shows a first embodiment of a valve 10 with a valve housing 12 including a valve chamber 14 with a longitudinal axis X, a first port (inlet) 16 and a second port (outlet) 18. In the embodiment shown, the valve 10 is a regulating valve for industrial refrigeration, which may be used for low and high pressure refrigerants with different phases of the refrigerant, including two phases of the refrigerant, such as e.g. a liquid refrigerant at the inlet and two-phase refrigerant at the outlet.

Within the valve chamber 14, a valve cylinder 20 is arranged, comprised of a top cylinder portion 22 and a bottom cylinder portion 24 and a valve seat gasket 26. The valve cylinder 20 comprises, in this first embodiment, two window openings 28a, 28b above the valve seat gasket 26, formed as radial openings in a wall of the valve cylinder 20 arranged opposite to each other.

A piston 30 is arranged axially moveable within the valve cylinder 20 along the axis X. The piston 30 includes a front surface 32 acting against the valve seat gasket 26 to close the valve 10, thus sealing off the window openings 28a, 28b in a lower position, or to provide variable degrees of opening of the valve 10 by fully or partially allowing fluid to flow from the inlet 16 via the interior of the valve cylinder 20 through the window openings 28a, 28b to the outlet 18.

The axial position of the piston 30 within the valve cylinder 20 is controlled by a drive arrangement 46 including a spindle 48 arranged within a spindle nut 50 and connected to a magnetic coupling 44. An external drive (not shown) coupled via the magnetic coupling 44 turns the spindle 48, thus adjusting the position of the piston 30, which is coupled to the spindle nut 50, to a desired axial position along the axis X.

The front surface 32 of the piston 30 is curved and has a central, axially protruding tip 42. The front surface 32 is thus formed to allow a smooth flow of fluid through the window openings 28a, 28b.

A balance chamber 34 is provided behind the piston 30, which in the presently shown embodiment comprises a central bore 52 in the interior of the piston, providing a hollow space. As will be further explained below, the balance chamber 34 is connected to the front surface 32 of the piston 30 by channels 38a, 38b traversing the piston 30. While the first channel 38a is fully shown in the sectional view of FIG. 1, only the connection of the second channel 38b to the central bore 52 is visible. The channels 38a, 38b lead to openings 36a, 36b (of which only one opening 36a is visible in FIG. 1) formed in the front surface 32 of the piston 30.

The balance chamber 34 serves to counterbalance the piston 30 against the fluid pressure from the inlet 16. Pressurized fluid passes through the openings 36a, 36b and connected channels 38a, 38b into the bore 52 and other parts of the balance chamber 34 to establish a pressure equilibrium, allowing the drive arrangement 46 to axially move the piston 30 to a desired axial position without having to act against the fluid pressure.

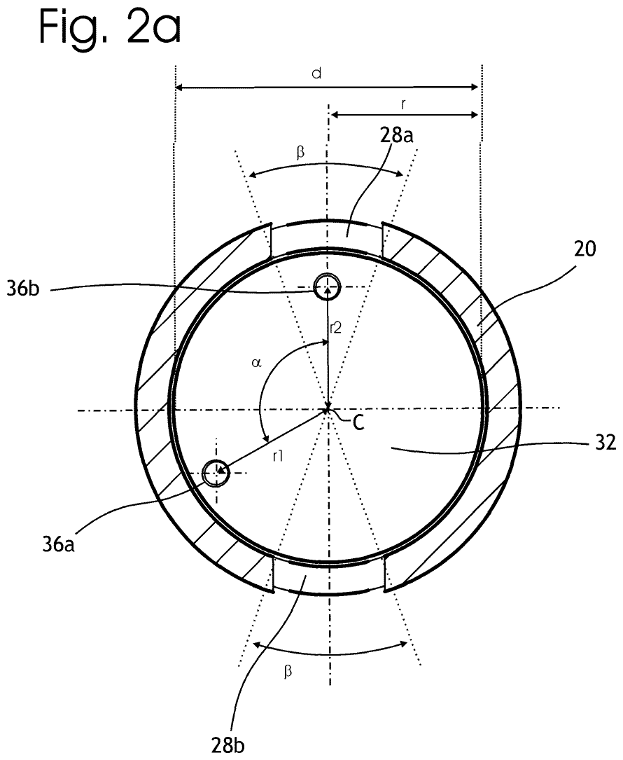

FIG. 2 shows a front view of the piston 30 and its front surface 32 and a sectional view of the valve cylinder 20. The window openings 28a, 28b are arranged on opposite sides. Within the front surface 32 of the piston 30, the openings 36a, 36b are visible.

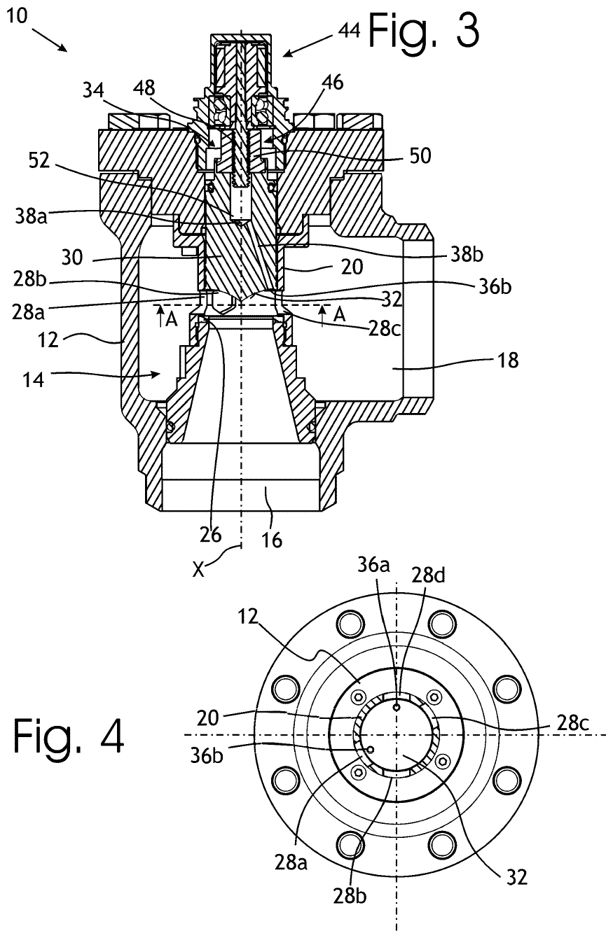

FIG. 3 is an enlarged view of the portion of FIG. 2 showing the front surface 32 of the piston 30 and the valve cylinder 20.

As shown, the first opening 36a is arranged under a first radius r1 defining a first radial distance from the center C of the front surface 32. The second opening 36b is arranged under a second radius r2 defining a second radial distance from the center C. It should be understood that the center C, the radii r1 and r2, and all further geometrical elements in FIG. 2a are defined, for clear reference, in a plane perpendicular to the central axis X, so that the curved shape of the front surface 32 including the tip 42 as shown in FIG. 1 is not relevant for these measurements.

The positions of the first and second openings 36a, 36b within the front surface 32 are chosen such that the first opening 36a is arranged further away from the center C than the second opening 36b. Thus, the length of the first radius r1 is greater than that of the second radius r2.

In the embodiment shown, the distance r1 is about 6% greater than r2.

It should be noted that both the first and the second opening 36a, 36b are arranged on the periphery of the front surface 32, distant from the center C. In the embodiment shown, the distance r2 corresponds to about 80% of the radial extension r of the front surface 32 (the radial extension r being equal to half the diameter d).

It should further be noted that the openings 36a, 36b and the center C are not arranged in a straight line. Rather, an angle a between the radii r1, r2 is at about 120°.

The window openings 28a, 28b define angular sections b of the front surface 32 bordered by radial lines (dotted lines in FIG. 2a) extending from the center C to the inner edges of the window openings 28a, 28b. These sections b are considered to be positioned in front of the window openings 28a, 28b. In the first embodiment as shown in FIG. 2a, the second opening 36b is arranged in front of the first window opening 28a, i.e. within one of the above defined sections b of the front surface 32. The first opening 36a is arranged outside of the defined sections b, thus not in front of one of the window openings 28a, 28b.

In operation of the valve 10, fluid under high pressure is applied at inlet 16. The drive arrangement 46 controls the degree of opening of the valve 10 by positioning the piston 30 along the axis X.

In a closed state of the valve, the periphery of the front surface 32 of the piston 30 acts against the valve seat gasket 26, thus sealing the interior of the valve cylinder 20, which is connected to the inlet 16, from the window openings 28a, 28b which are connected to the outlet 18.

In the closed state the fluid pressure in the balance chamber 34 is established to be equal to the fluid pressure in front of the front surface 32 via the openings 36a, 36b and their connections to the balance chamber 34 through the channels 38a, 38b. In the closed state the fluid pressure in front of the front surface 32 will be uniform and equal to the fluid pressure in the balance chamber 34, so that the piston 30 is fully balanced and can be moved by the drive arrangement 46 without having to act against the fluid pressure.

As the valve 10 is opened by upward movement of the piston 30, a flow of fluid is established from the inlet 16 to the outlet 18 through the window openings 28a, 28b. The fluid pressure in front of the front surface 32 of the piston 30 changes and a non-uniform pressure distribution is established.

The openings 36a, 36b can be understood to measure the fluid pressure at their specific locations, each representing a sample of fluid pressure values in the non-uniform distribution formed. In consequence, a resulting fluid pressure is established in the balance chamber 34 which is a combination, such as an average, of the fluid pressure values present in front of the openings 36a, 36b.

It has been found that the above-described positioning of the openings 28a, 28b is effective in establishing a fluid pressure in the balance chamber 34 which adequately reflects an overall average of the fluid pressure acting on the front surface 32 of the piston 30. Thus, in spite of the non-uniform distribution of the fluid pressure over the front surface 32, suitable balancing of the piston 30 can be achieved via the openings 36a, 36b positioned as shown, i.e. the forces acting on the piston 30 as a result of the fluid pressure both in the balance chamber 34 and in front of the front surface 32 largely cancel out.

FIGS. 3, 4 show a second embodiment of a valve 10, which in many respects corresponds to the valve 10 according to the first embodiment. Common parts in both embodiments are designated by the same reference numerals. In the following, only the differences between the embodiments will be discussed in detail.

The valve 10 according to the second embodiment differs from the valve 10 according to the first embodiment by a different number and configuration of window openings in the valve cylinder 20. In the second embodiment, there are four window openings 28a, 28b, 28c, 28d distributed around the circumference of the valve cylinder 20 as visible in particular from FIG. 4.

It should be noted that the same piston 30 is used for both the configurations of the first and second embodiments, i.e. the number and positioning of the openings 36a, 36b in the front surface 32 of the piston 30 is the same.

In the case of four window openings 28a-d in the second embodiment, both openings 36a, 36b are arranged in front of window openings 28a, 28d. However, it has been found that the radial positioning of the openings 36a, 36b under different distances r1, r2 from the center C still provides for suitable balancing of the piston 30, which is believed to be due to the more uniform pressure distribution resulting from a larger number of window openings 28a-d.

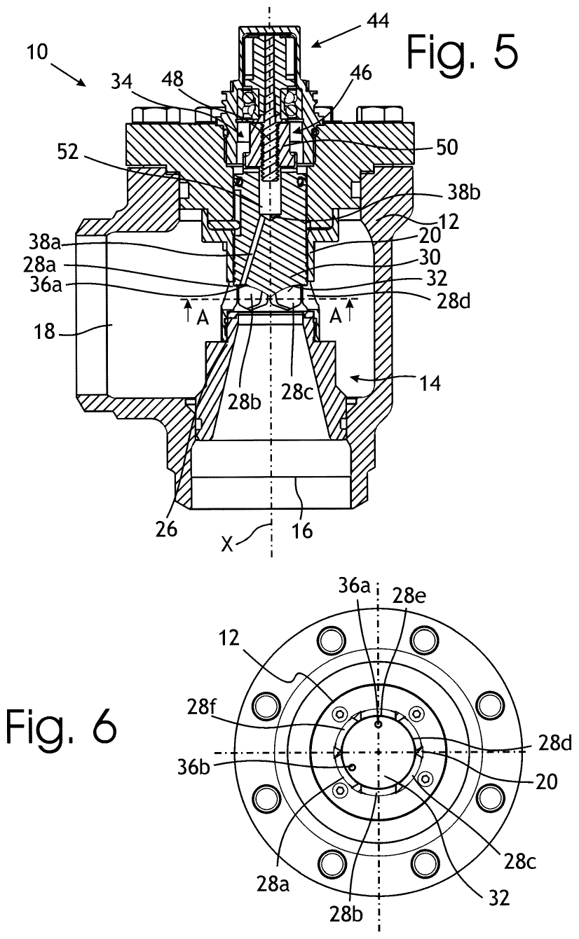

FIGS. 5, 6 show a third embodiment of a valve 10. The third embodiment corresponds to the first and second embodiment in most parts, so that the same reference numerals are used and only differences between the embodiments will be mentioned.

The valve 10 according to the third embodiment differs from the valve 10 according to the first and second embodiment by the number and configuration of window openings in the valve cylinder 20. In the third embodiment, there are six window openings 28a-f, evenly distributed around the circumference of the valve cylinder 20 as visible from FIG. 6. The same piston 30 is used also in the third embodiment.

The same piston 30 with the special positioning of the openings 36a, 36b in the front surface 32 is thus usable in different valve configurations, allowing a reduction of different parts in a series of valve models with different properties such as nominal capacity. In all cases, a good balancing of the piston 30 is achieved.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A valve for regulating a fluid flow between a first and a second port of a valve housing, said valve comprising
a piston movably arranged within a valve cylinder, the piston comprising a front surface, the piston being axially movable within the valve cylinder at least between an opened position in which said fluid can flow between said first and second ports and a closed position in which the front surface of the piston blocks a flow of the fluid,
a balance chamber being arranged behind the piston, opposite to the front surface,
and wherein the front surface of the piston comprises at least a first opening with a first channel connected to the balance chamber and a second opening with a second channel connected to the balance chamber, each of said first and second opening being arranged at a distance from a center of the front surface of the piston,
wherein the first opening is arranged at a first radial distance from the center of the front surface of the piston, and the second opening is arranged at a second radial distance from the center of the front surface of the piston,
wherein the first distance is greater than the second distance.

2. The valve according to claim 1, wherein
the first distance is at least 3% greater than the second distance.

3. The valve according to claim 1, wherein
the piston has a radial extension measured at the front surface, wherein each of the first radial distance and the second radial distance are at least 40% of the radial extension.

4. The valve according to claim 1, wherein
the valve cylinder comprises one or more window openings
wherein one of the first and second openings is arranged at a first position within the front surface of the piston which is in front of one of the window openings, and
wherein the other one of the first and second openings is arranged at a second position within the front surface of the piston which is not front of one of the window openings.

5. The valve according to claim 1, wherein
the first and second openings are arranged at positions within the front surface of the piston defining a first radius from the center of the front surface of the piston to the first opening and a second radius from the center of the front surface of the piston to the second opening,
wherein an angle formed between the first and second radii is greater than 20° and less than 160°.

6. The valve according to claim 1, wherein
the piston comprises a hollow space,
and the channels connect the first and second opening to the hollow space.

7. The valve according to claim 1, wherein
a drive arrangement is provided to control an axial position of the piston.
